(19) United States
(12) Patent Application Publication
(10) Pub. No.: US 2026/0299574 A1
(43) Pub. Date: Oct. 1, 2026

(54) SYSTEMS AND METHODS FOR EQUIPMENT HEALTH MONITORING

(71) Applicant: BP Exploration Operating Company Limited, Middlesex (GB)

(72) Inventors: Aaron Brazier, Valparaiso, IN (US); Greg Hickey, Surrey (GB); Malia Kilpinen, Surrey (GB)

(73) Assignee: BP Exploration Operating Company Limited, Middlesex (GB)

(21) Appl. No.: 19/570,459

(22) Filed: Mar. 18, 2026

Related U.S. Application Data
(60) Provisional application No. 63/779,989, filed on Mar. 28, 2025.

(51) Int. Cl. G05B 23/02; G01M 99/00

(52) U.S. Cl. CPC G05B 23/0224; G01M 99/005; G05B 23/027

(57) ABSTRACT

A method includes identifying a set of sensor pairs, where each sensor pair in the set of senor pairs has a first correlation value greater than a predetermined threshold; receiving sensor data from the plurality of sensors; calculating a second correlation value for each sensor pair in the set of sensor pairs based on the received sensor data; calculating a deviation value for each sensor pair in the set of sensor pairs, where the deviation value comprises a difference between the first correlation value and the second correlation value for that sensor pair; and generating an alert in response to deviation value(s) for at least a predetermined number of the sensor pairs being greater than a statistical threshold value.

### CROSS-REFERENCE TO RELATED APPLICATIONS

This application claims benefit of U.S. provisional patent application No. 63/779,989 filed Mar. 28, 2025, entitled “Systems and Methods for Equipment Health Monitoring”, which is hereby incorporated herein by reference in its entirety.

### STATEMENT REGARDING FEDERALLY SPONSORED RESEARCH OR DEVELOPMENT

Not applicable.

### BACKGROUND

The petroleum industry relies on various equipment to extract, process, and transport hydrocarbons. Unplanned failures may lead to costly downtime, environmental damage, and safety hazards. Equipment health monitoring (EHM) is an aspect of asset management in the petroleum industry, among other industries. EHM includes monitoring equipment performance and condition to identify potential issues before they escalate into failures. The complexity and diversity of equipment in the petroleum industry, coupled with the harsh operating environments, may lead to a wide range of failure modes, some of which may not be well understood or easily predictable.

Some conventional EHM approaches focus on specific failure modes, such as bearing wear, vibration, or temperature anomalies. These approaches generally rely on predefined models or rules based on known failure mechanisms. While these approaches may be effective in detecting known failure modes, they have limitations when it comes to identifying “unknown unknowns”, or unforeseen failures that do not follow established patterns or have not been previously encountered.

### SUMMARY

In an embodiment, a method includes identifying a set of sensor pairs, where each sensor pair in the set of senor pairs has a first correlation value greater than a predetermined threshold; receiving sensor data from the plurality of sensors; calculating a second correlation value for each sensor pair in the set of sensor pairs based on the received sensor data; calculating a deviation value for each sensor pair in the set of sensor pairs, where the deviation value comprises a difference between the first correlation value and the second correlation value for that sensor pair; and generating an alert in response to deviation value(s) for at least a predetermined number of the sensor pairs being greater than a statistical threshold value.

In another embodiment, a system includes a plurality of sensors and an electronic device coupled to the plurality of sensors. The electronic device includes one or more processors and a memory coupled to the one or more processors and storing instructions that, when executed by the one or more processors, cause the electronic device to be configured to: identify, from the plurality of sensors, a set of sensor pairs, where each sensor pair in the set of senor pairs has a first correlation value greater than a predetermined threshold; receive sensor data from the plurality of sensors; calculate a second correlation value for each sensor pair in the set of sensor pairs based on the received sensor data; calculate a deviation value for each sensor pair in the set of sensor pairs, where the deviation value comprises a difference between the first correlation value and the second correlation value for that sensor pair; and generate an alert in response to deviation value(s) for at least a predetermined number of the sensor pairs being greater than a statistical threshold value.

In yet another embodiment, a non-transitory computer-readable medium stores instructions that, when executed by one or more processors of an electronic device, cause the electronic device to be configured to: identify, from a plurality of sensors, a set of sensor pairs, where each sensor pair in the set of senor pairs has a first correlation value greater than a predetermined threshold; receive sensor data from the plurality of sensors; calculate a second correlation value for each sensor pair in the set of sensor pairs based on the received sensor data; calculate a deviation value for each sensor pair in the set of sensor pairs, where the deviation value comprises a difference between the first correlation value and the second correlation value for that sensor pair; and generate an alert in response to deviation value(s) for at least a predetermined number of the sensor pairs being greater than a statistical threshold value.

Embodiments described herein include a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of a distribution facility in accordance with embodiments described herein;

FIG. 2 is a block diagram illustrating components of an equipment health monitoring system in accordance with embodiments described herein;

FIG. 3 is a graph of historical data from sensors over time in accordance with embodiments described herein;

FIG. 4 is a graph of comparative values of various sensor data over time in accordance with embodiments described herein;

FIG. 5 is a flowchart of a method for equipment health monitoring in accordance with embodiments described herein; and

FIG. 6 is a block diagram of a computer system configured to implement one or more embodiments described herein.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Thus, while several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

Equipment health monitoring systems predict and prevent equipment failures. Equipment failures may lead to costly downtime, production losses, and safety hazards. To mitigate these risks, equipment health monitoring systems typically utilize sensor data to track equipment performance and identify anomalies that may indicate impending failures. In other cases, equipment health monitoring systems may not use sensor data, and instead provide a system score based on compliance with inspection results and/or adherence to a prescribed maintenance regime.

However, existing approaches to equipment health monitoring generally fall short in addressing complex failure modes, particularly those that are not specifically anticipated or modeled. In other words, conventional equipment health monitoring typically relies on failure-mode-specific models or machine learning models. Developing and maintaining these models may be time-consuming and expensive because they generally require expertise in both the equipment's operation and the specific failure modes being monitored, as well as expertise in maintaining the underlying model.

Moreover, failure-mode-specific models may be limited in detecting unforeseen or complex failures (e.g., “unknown unknowns”) because they are designed to detect specific types of failures. These models sometimes require a thorough understanding of the equipment's underlying physics and the specific causes that lead to failure. Such models are designed to identify specific patterns or deviations from normal operations that are known to be associated with a particular failure mode. If a failure occurs due to an unknown or unanticipated mechanism, these models may miss or misidentify early warning signs, leading to delayed detection.

In addition to the limitations of failure-mode-specific models, conventional equipment health monitoring may face scalability and implementation challenges. Some approaches may require manual configuration and tuning for each piece of equipment being monitored, which may be a time-consuming and labor-intensive process, making them difficult to scale across large industrial operations. This may make it difficult to monitor a large number and/or different types of assets, particularly in industries with diverse equipment types and operating conditions.

Further, some existing solutions rely on complex machine learning algorithms, which may be computationally expensive and require specialized expertise to develop and maintain. Machine learning-based models can potentially detect a wider range of failure modes by learning patterns from historical data. However, they may require large amounts of labeled data for training, which may not be readily available in many industrial settings. This may limit their applicability in environments with limited computational resources or where rapid deployment is desired, hindering their widespread adoption.

Thus, both failure-mode-specific and machine learning-based models have limitations. Failure-mode-specific models are unable to detect “unknown unknowns,” or failures that do not match any pre-existing patterns. While potentially more flexible, machine learning models may be data-hungry and may struggle with limited or noisy data.

Embodiments of this disclosure address the above-described challenges and limitations by providing an equipment health monitoring system that identifies one or more sensor pairs associated with a piece of equipment that have a historical correlation value greater than a threshold. The historical correlation value may be determined based on historical data from each sensor in the sensor pair. In other words, the identified sensor pairs typically generate data (e.g., historical data) that are at least relatively correlated. Once a set of such relatively correlated sensor pairs has been identified, sensor data continues to be received, and current correlation values for the identified sensor pairs are calculated based on the received sensor data. These current correlation values are thus based on relatively recent data from the sensors, as opposed to historical sensor data.

The embodiments described herein further calculate a deviation value for each identified sensor pair based on the historical correlation value and the current correlation value for that sensor pair. The calculated deviation value thus reflects how different the current correlation value for the sensor pair is from what has historically been the case for that sensor pair. If the deviation value for a sensor pair (or at least a certain number of sensor pairs) is greater than a threshold value, an alert may be generated for the associated piece of equipment. In response to an alert being generated, one or more remedial actions may be taken, such as performing maintenance tasks and/or repairs, adjusting operation parameter(s) of the equipment, resetting the equipment, powering off the equipment, and the like.

In this way, the embodiments described herein provide an EHM solution that is scalable, simple to implement, and capable of detecting multiple failure modes, including those not specifically anticipated or modeled (e.g., “unknown unknowns”). These embodiments may improve computational efficiency and ease of deployment across a number of equipment assets by identifying anomalies based on changes in correlation values between sensors, which may be indicative of potential equipment failures.

As described further below, applying a statistical approach to identify the changes or deviations in current correlation values from historical correlation values reduces the need for prior knowledge of specific failure modes or underlying physics. Generating alerts or taking other remedial action based on deviations in the correlation between sensor data enables identifying anomalies indicative of potential equipment issues (e.g., failure), regardless of the specific cause or underlying mechanism of the failure. The disclosed embodiments may identify relevant (e.g., relatively highly correlated) sensors and their correlations based on asset models (e.g., digital representations of equipment and their associated sensors), reducing the need for manual selection and configuration and improving efficiency by automatically identifying relevant sensors and their correlations. These embodiments are described further below, with reference made to the accompanying figures.

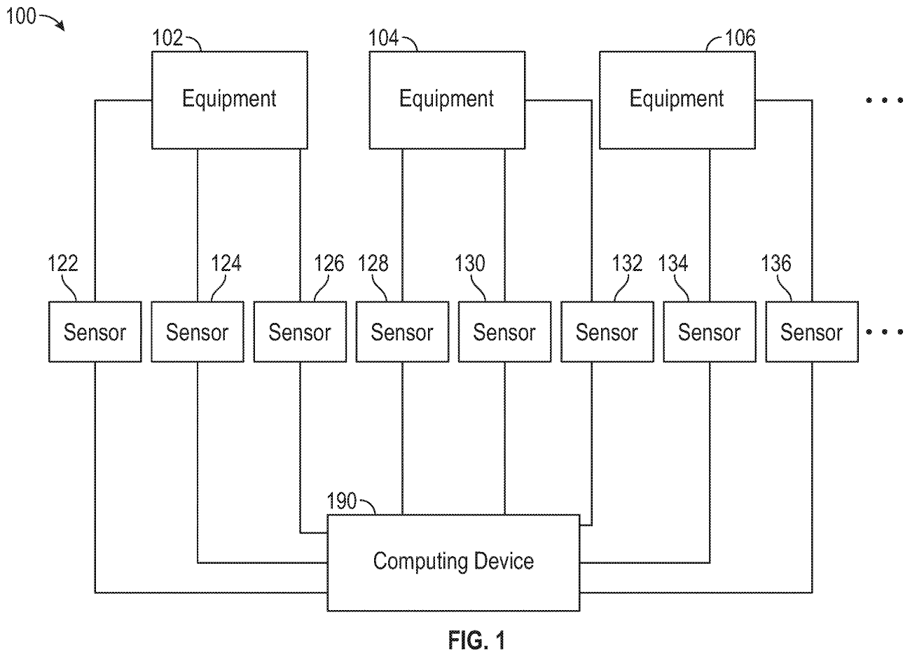

FIG. 1 is a block diagram of a facility 100 in accordance with embodiments described herein. Facility 100 may be an industrial or manufacturing plant (e.g., a chemical and/or hydrocarbon processing plant), power station, or other facility where equipment health monitoring occurs. Within facility 100, there may be multiple pieces of equipment 102, 104, 106. The equipment 102, 104, 106 may include pumps, turbines, motors, generators, processing equipment, and other such devices.

Each piece of equipment may be associated with (e.g., coupled to) multiple sensors. In the example of FIG. 1, equipment 102 is associated with sensors 122, 124, 126; equipment 104 is associated with sensors 128, 130, 132; and equipment 106 is associated with sensors 134, 136. In other examples, the facility 100 may include additional pieces of equipment and sensors associated therewith; the scope of this disclosure is not necessarily limited to a particular number of equipment and/or associated sensors.

The sensors 122-136 are configured to collect data related to and/or indicative of the performance of the equipment 102, 104, 106 associated therewith. For example, the sensors 122-136 may collect data related to various parameters such as temperature, pressure, vibration, flow rate, power consumption, acoustic emissions, and other metrics related to the performance of equipment 102, 104, 106. It should be appreciated that FIG. 1 is schematic and exemplary in nature, and that the embodiments described herein may be applied to different arrangements of sensors and equipment. For example, a facility 100 may include multiple types of same equipment, sensor(s) may be shared between pieces of equipment, and the like.

In some examples, the sensors 122-136 may sense parameters related to subcomponents of the equipment 102, 104, 106, such as bearings, fluids flowing therethrough, and/or other components within the equipment 102, 104, 106. The sensors 122-136 may include pressure sensors for various fluids, gasses, and/or hydraulic systems; vibration sensors for rotating equipment, which may indicate potential misalignment, imbalance, or wear; flow sensors for various fluids and/or gasses through pipelines; current and/or voltage sensors for motors, generators, or other electrical components; and acoustic sensors such as for high-or low-frequency sounds emitted by materials undergoing stress or damage.

The specific types and number of sensors 122-136 used may depend on the type of equipment 102, 104, 106 in the facility 100. For example, in a centrifugal pump, temperature sensors may be placed on bearings and the motor casing, pressure sensors may be placed on the pump inlet and outlet, vibration sensors may be placed on the motor and pump casing, and a flow rate sensor may be placed on the discharge line. In general, a variety of sensors may be useful to capture a more comprehensive picture of the health of equipment 102, 104, 106.

A computing device 190 (e.g., a server, industrial computer, or cloud-based system) coupled to sensors 122-136 and configured to receive and/or process data from the 122-136. In some examples, the computing device 190 also implements an equipment health monitoring system, which may include generating alerts, in accordance with various embodiments. The sensors 122-136 may be coupled to the computing device 190 via a network, which may be wired (e.g., Ethernet) or wireless (e.g., Wi-Fi, Bluetooth). The network facilitates the transmission of sensor data from the sensors 122-136 to the computing device 190, and vice versa (e.g., for control signals).

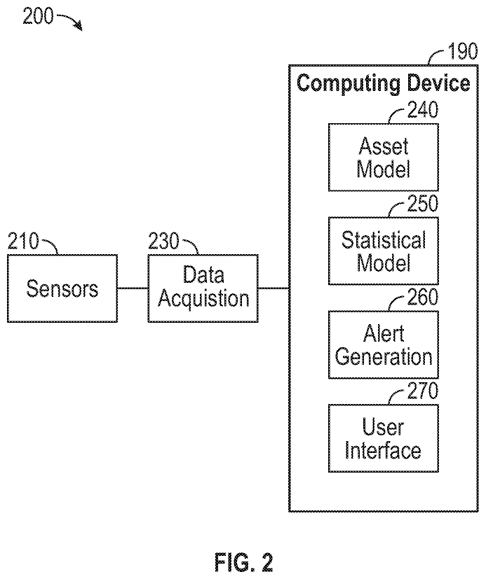

FIG. 2 is a block diagram of an equipment health monitoring system 200 according to the embodiments described herein. Equipment health monitoring system 200 includes sensors 210, which may be similar to sensors 122-136 described above with respect to FIG. 1. As described above, the sensors 210 may be associated with equipment (e.g., equipment 102, equipment 104, equipment 106) in various types of facilities. The equipment health monitoring system 200 also includes a data acquisition system 230 coupled to the sensors 210, and to the computing device 190. In the example of FIG. 2, the computing device 190 includes an asset model 240, a statistical model 250, an alert generation component 260, and a user interface 270. The components of the computing device 190 are described further below.

The data acquisition system 230 receives and processes raw sensor data and provides the processed data to the computing device 190 for further analysis. The data acquisition system 230 may perform signal conditioning, analog-to-digital conversion (ADC), and other data processing and aggregation operations. The data acquisition system 230 may also provide data storage functionality.

In some examples, signal conditioning refers to preparing raw analog signals from the sensors 210 for digital conversion. Signal conditioning may include amplification, filtering, and isolation to enhance the accuracy and reliability of measurements. For example, signal conditioning may convert a 4-20 mA signal to an appropriate voltage level for an ADC component.

In some embodiments, the data acquisition system 230 may perform initial processing of digital sensor data (e.g., provided by the ADC). Such initial processing may include averaging, filtering, or other signal-processing techniques to reduce noise and/or extract relevant features. The equipment health monitoring system 200 may also aggregate data over time intervals (e.g., 10-minute averages) to reduce data volume and improve computational efficiency. Further, the data acquisition system 230 is configured to transmit the processed sensor data to the computing device 190 for storage and further analysis.

The data acquisition system 230 may be implemented in various forms, depending on the specific requirements of the application. For example, the data acquisition system 230 may be implemented as an embedded system, which is a dedicated hardware device with integrated sensors, signal conditioning, ADC, and communication capabilities. Such an option may be useful in harsh industrial environments due to its robustness and reliability. Additionally, the data acquisition system 230 may be implemented as a remote terminal unit (RTU), which is a more sophisticated embedded system that can perform additional functions such as data logging, control, and communication with other systems. Further, the data acquisition system 230 may be implemented as a programmable logic controller (PLC), which is a programmable computer used for automation and control. PLCs may be equipped with data acquisition modules to interface with sensors. Alternatively, the data acquisition system 230 may be implemented as an industrial personal computer (PC), which is a standard personal computer running specialized data acquisition software and equipped with appropriate interface cards. The choice of implementation may depend on factors such as cost, complexity, scalability, and the specific requirements of the equipment being monitored. In general, it should be appreciated that the data acquisition system 230 is depicted schematically, and could in practice include a number of devices and storage sites including data loggers, PLCs, computing devices, and databases, which may be aggregated across one or more networks, and which may span one or more facilities.

Referring to the example of the centrifugal pump (discussed above), the sensors 210 may continuously collect data on temperature, pressure, vibration, and flow rate. The data acquisition system 230 may sample and digitize the sensor signals, converting them into a format suitable for processing. The digitized data may then be transmitted to the asset model 240 of the computing device 190.

The asset model 240 serves as a central knowledge repository and information backbone of the equipment health monitoring system 200. The asset model 240 provides contextual information for interpreting and analyzing the sensor data associated with the equipment 102, 104, 106. In some examples, the asset model 240 acts as a digital twin of the equipment 102, 104, 106, as well as the sensors 122-136 (e.g., sensors 210) associated therewith. For example, the asset model 240 may represent (e.g., in one or more data structures) various details of the equipment 102, 104, 106 and sensors 210, such as make/model information, sub-components thereof, connections and/or topographical layout, and historical performance data.

The asset model 240 may be structured as a hierarchical or graph-based representation, allowing for storage and retrieval of information. The asset model 240 may include equipment metadata, sensor mappings, historical sensor data, equipment hierarchy, and other relevant data. Equipment metadata may include descriptive information about the equipment 102, 104, 106, such as its type (e.g., pump, compressor, turbine), manufacturer, model, serial number, location, installation date, and maintenance history. Relatedly, the asset model 240 may map each sensor 210 to its associated equipment 102, 104, 106. Further, the asset model 240 may store historical sensor data.

As described further below, such historical data may serve as the basis for training the statistical model 250 and establishing baseline correlation threshold(s) for identifying anomalies and/or failures of the equipment 102, 104, 106. In these examples, correlation may refer to a statistical measure that expresses expressing the extent to which two variables (e.g., data from two sensors 210) are related.

Additionally, the asset model 240 may represent the hierarchical structure of the equipment, indicating the relationships between different components and subsystems. This may allow for data analysis at various granularity levels, from individual components to the entire system. The asset model 240 may also store other relevant data, such as maintenance records, operating procedures, and engineering specifications. This information may provide context for interpreting sensor data and making informed decisions about equipment health.

The asset model 240 may be implemented using various technologies, such as relational databases, graph databases, or specialized asset management software. The choice of technology may depend on factors such as data volume, complexity, and desired functionality. In the equipment health monitoring system 200, the asset model 240 may be integrated with the other components, including the data acquisition system 230, the statistical model 250, and alert generation 260.

Referring back to the example of the centrifugal pump, the asset model 240 may receive sensor data (e.g., from the data acquisition system 230) and associate it with corresponding pump and sensor identifiers. Historical data for the pump, collected over the past year, may also be accessible by the asset model 240.

The statistical model 250 may be an analytical engine (e.g., software executed by one or more processors of the computing device 190) that implements analysis and various related functionality of the equipment health monitoring system 200. The statistical model 250 learns normal (or expected) behavior of correlated sensor pairs, establishing thresholds for detecting anomalies and/or failures, and evaluating sensor data against these thresholds. The evaluation may be performed periodically based on received sensor data. Core functions of the statistical model 250 may include training, calculations, and anomaly detection, and are described further below.

The statistical model 250 may utilize historical sensor data retrieved from the asset model 240 to train a statistical model for sensor pairs that are identified as being sufficiently correlated. This training process may include applying a hybrid statistical approach, combining multiple metrics to capture both the magnitude and rate of change in sensor readings. This training may result in a set of correlation thresholds specific to each sensor pair, representing the boundaries of (e.g., thresholds that constrain) normal behavior.

During operation, the statistical model 250 receives new sensor data from the data acquisition system 230. For each correlated sensor pair, the statistical model 250 may calculate a correlation value based on current sensor values (i.e., data received from the sensors 210 relatively recently) and the previously trained statistical model, which is trained based on historical data from the sensors 210. This correlation value may quantify how closely the current sensor behavior aligns with the established normal behavior. The calculated correlation value for each sensor pair may then be compared to its respective correlation threshold. If the correlation value exceeds the threshold, that may indicate a strong enough deviation from normal behavior, which may indicate a potential anomaly or impending equipment failure.

The hybrid statistical approach employed by the statistical model 250 may allow for detecting diverse failure modes, including “unknown unknowns.” This approach may combine two distinct metrics: absolute difference and an average historical value for each correlated sensor pair. In the following examples, reference is generally made to the average historical value for each correlated sensor pair; however, in other embodiments, a best-fit line deviation metric may be used instead. The scope of the present disclosure should not be interpreted as being limited to a particular implementation unless explicitly recited in one or more claims. The absolute difference metric quantifies the absolute difference between the current sensor values of a correlated pair and the median value of historical absolute differences for that pair. This captures the magnitude of deviation from the typical range of values. On the other hand, the average historical value for each correlated pair enables determining the deviation of the current sensor values from an average value calculated from historical data. Such deviation may be referred to as an average historical value deviation metric. This captures the rate of change in sensor values and may reveal trends or shifts in behavior that might not be apparent from the absolute values alone. By combining these two metrics, the hybrid statistical approach may provide a more comprehensive and sensitive measure of correlation breakdown, allowing for the detection of subtle anomalies that conventional methods might miss.

The statistical model 250 may be implemented using various software tools and programming languages. The algorithms used for training the models and calculating correlation values may be tailored to the types of sensors and equipment being monitored. The statistical model 250 may be designed to be adaptable and may be configured to accommodate different types of sensors, equipment, and operating conditions. This adaptability may aid in ensuring that the equipment health monitoring system 200 is effective across diverse industrial settings.

The statistical model 250 may work with other components of the equipment health monitoring system 200 by receiving historical sensor data and equipment metadata from the asset model 240, receiving sensor data from the data acquisition system 230, and sending alert signals to the alert generation system 260 when anomalies are detected. This approach may allow the equipment health monitoring system 200 to function in a more integrated manner, providing a more comprehensive solution for equipment health monitoring.

Referring back to the example of the centrifugal pump, the statistical modeling system 250 may access the historical sensor data to identify highly correlated pairs of highly correlated sensors (e.g., bearing temperature and vibration). For each correlated pair, the system may train a statistical model using the hybrid approach, combining absolute difference and average historical value deviation metrics. The model may establish a correlation threshold for each pair, representing the expected range of variation between data from that sensor pair under normal operating conditions. The computing device 190 (or the statistical model 250 thereof) may receive relatively recent data from the sensors 210 and calculate correlation values for the identified pair(s) of sensors 210. These correlation values may then be compared to the established thresholds.

Alert generation 260 may occur in response to the correlation values calculated by the statistical model 250. For example, alerts may be triggered based on predefined thresholds and post-processing rules. Functions of alert generation 260 may include threshold comparison, post-processing, alert refinement, alert prioritization, and alert communication.

For threshold comparison, alert generation 260 may receive correlation values for each correlated sensor pair from the statistical model 250. Alert generation 260 may then occur based on a comparison of these correlation values to the corresponding correlation thresholds accessible by the asset model 240. For example, a preliminary alert may be generated if a correlation value exceeds its threshold, indicating a deviation from expected behavior.

Alert generation 260 may include application of post-processing rules to refine the preliminary alerts and reduce false positives. These rules may include minimum duration, alert suppression, and percentage threshold. For example, in implementing a minimum duration rule, an alert may only be triggered if the correlation value remains above the threshold for a minimum duration, ensuring that the anomaly is persistent and not just a transient fluctuation. In another example, in implementing an alert suppression rule, alerts for a specific sensor pair may be suppressed for a period after a previous alert has been generated, preventing repetitive notifications for the same issue. In yet another example, in implementing a percentage threshold rule, an alert may be triggered if a percentage of correlated sensor pairs exceed their thresholds, indicating a more widespread issue with the equipment.

Alert generation 260 may be prioritized based on severity, urgency, or other criteria. This may allow users to focus on issues deemed critical and take timely action. Further, the generated alerts may be communicated to the user interface 270 for display and further action. The alerts may be presented in various formats, such as text messages, emails, visual alarms, or integration with existing maintenance management systems.

Alert generation 260 may be implemented as software executed by one or more processors of the computing device 190. The algorithm(s) and logic used for alert generation may be customized based on the system's desired sensitivity, specificity, and response time. The post-processing rules may also be tailored to the specific equipment and operating environment. For example, the minimum duration and suppression period may be adjusted based on the typical time scales of failure development for the equipment in question.

Alert generation 260 may interact with other components of the equipment health monitoring system 200 to enable a closed-loop feedback mechanism. For example, correlation values are received from the statistical model 250, the asset model 240 may be accessed to retrieve correlation thresholds and equipment information, and alerts are communicated to the user interface 270 for user action. User feedback may affect future alert generation 260, such as by adjusting alert thresholds thus improving the accuracy of future alerts. Such an integrated approach may allow alert generation 260 to adapt to changing conditions and improve its performance over time.

Referring back to the example of the centrifugal pump, alert generation 260 may be triggered regarding anomalies in the centrifugal pump. For example, if a correlation value exceeds its threshold, a preliminary alert is generated. A postprocessing rule may be applied, such as determining whether the alert has persisted for a minimum duration (e.g., 1 day), and verifying that no recent alert has been generated for the same sensor pair. If the alert passes these checks, it may be considered valid and communicated to the user interface 270.

The user interface 270 may serve as one point of interaction between the equipment health monitoring system 200 and its users. The user interface 270 may be responsible for presenting the equipment health monitoring analysis results in a clear, intuitive, and actionable manner. The user interface 270 acts as a window into the system's inner workings, allowing users to visualize equipment health status, review alerts, and make informed decisions about maintenance and operational adjustments. Functions and features of the user interface 270 may include a dashboard overview, alert visualization, historical data and trends, sensor pair visualization, customizable views and filters, and reporting and analytics.

The user interface 270 may feature a central dashboard that provides an overview of the equipment's health status. This dashboard may display desired metrics such as overall health scores, trends over time, and a summary of active alerts. Alerts generated by the alert generation system 260 may be displayed on the user interface 270. These alerts could include visual cues like color-coded indicators, flashing lights, or audible alarms. The alerts may also be accompanied by detailed information about the affected sensor pair, the nature of the anomaly, and the potential impact on equipment performance.

The user interface 270 may allow users to access historical sensor data and visualize trends over time. This may help identify long-term patterns, gradual degradation, or recurring issues that may not be immediately apparent from real-time data. Further, the user interface 270 may provide visualizations of individual sensor pairs'correlation values and thresholds. This may allow users to delve deeper into the analysis and understand the specific factors contributing to the overall equipment health status.

The user interface 270 may be customized to display different views and filters based on user preferences or specific needs. For example, users may be able to filter alerts by severity, equipment type, or location. Additionally, the user interface 270 may offer reporting and analytics features, allowing users to generate reports on equipment health trends, maintenance activities, and overall system performance.

The user interface 270 may be implemented as a web-based application, a desktop software, or a mobile app. The user interface 270 may be accessed through various devices, such as computers, tablets, or smartphones, providing flexibility and convenience for users. The design of the user interface 270 may aid in ensuring that it is intuitive, easy to use, and provides the information users may wish to see clearly and concisely. The user interface 270 may be designed with the user in mind, incorporating features like customizable dashboards, intuitive navigation, and clear visualizations.

Referring back to the example of the centrifugal pump, the user interface 270 may a dashboard view of the pump's overall health status, indicating any active alerts. Users may be able to drill down into the details of each alert, viewing the affected sensor pair, the correlation value, and historical trends. Based on this information, maintenance personnel may be able to investigate the issue, determine the root cause, and take corrective action to prevent pump failure.

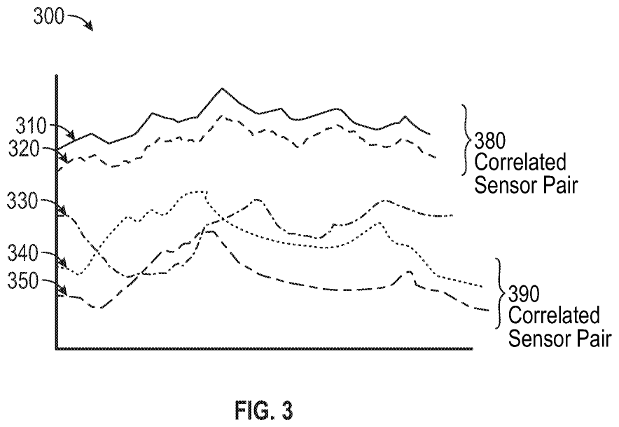

FIG. 3 shows graph 300 of waveforms of historical data from various sensors over time. The graph 300 shows the values of sensor 310, sensor 320, sensor 330, sensor 340, and sensor 350 mapped across a given time period (e.g., two months).

In accordance with various examples described herein, a set of sensor pairs is identified from a plurality of sensors based on analyzing historical sensor data to determine degrees of correlation between different sensor pairs. Each sensor pair in the set of sensor pairs has a correlation value, which is a statistical measure that quantifies the strength and direction of a linear relationship between the historical sensor data of two sensors within a pair.

In graph 300, the values of sensor 310 and sensor 320 are correlated because they generally track a similar linear relationship across time. Similarly, the values of sensor 340 and sensor 350 are correlated. However, the values of sensor 330 are uncorrelated with respect to the values of sensor 310, sensor 320, sensor 340, and sensor 350. Relatedly, the values of sensor 310 and sensor 320 are uncorrelated with respect to the values of sensor 340 and sensor 350. Thus, sensor 310 and sensor 320 may be identified as a sensor pair 380, while sensor 340 and sensor 350 may be identified as a sensor pair 390.

Sensor values may be temporally correlated, as shown in the case of sensor 310 and sensor 320, or may exhibit temporal displacement or time-lagged correlation, as shown in sensor 340 and sensor 350. Relatedly, sensor values may exhibit lagged waveform similarity, offset-dependent correlation, or time-variant correlation coefficients. Sensor values may also exhibit inverse correlation, and the scope of the present disclosure should not be interpreted as being limited to a particular type of correlation unless explicitly recited in one or more claims.

A predetermined correlation threshold may be used to exclude from the set of identified sensor pairs sensor pairs that do not exhibit sufficiently strong correlations. For example, a threshold of 0.9 or higher might be used to select only those sensor pairs with a strong positive correlation. This threshold may be set based on empirical observations, domain knowledge, or statistical analysis of the historical data. In the case of graph 300, for example, if the sensor pair 390 is determined to have a correlation value of 0.80, the sensor pair 390 is not included in the set of identified sensor pairs, whereas the sensor pair 380, having a correlation value of 0.95, is included in the set of identified sensor pairs.

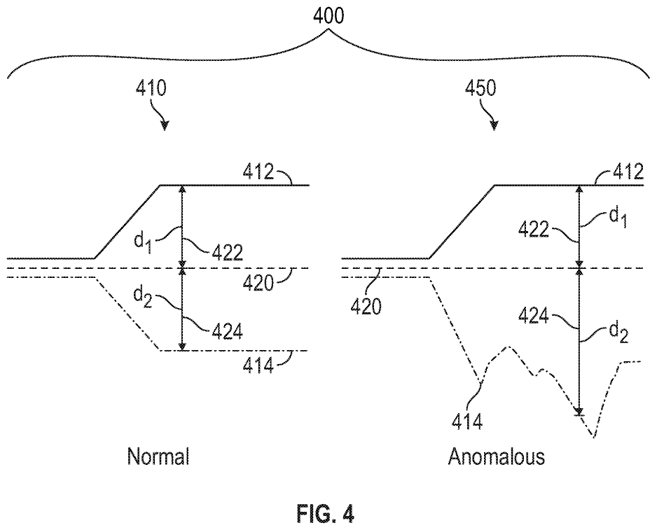

FIG. 4 shows comparative plots 400 of values of various sensor data over time in demonstrating the concept of normal and anomalous behavior in inversely correlated sensor pairs in accordance with embodiments described herein. Normal (or expected) behavior is represented in plot 410, while anomalous behavior is represented in plot 450.

The plot 410 depicts a scenario where first and second sensor signals exhibit normal, inversely correlated behavior. Values of a first sensor over time are represented by 412, and values of a second sensor over time are represented by 414. An average 420 of 412, 414 (e.g., the average of fitted curves based on 412, 414) is also shown. The vertical distances (d₁ 422, d₂ 424) between each sensor value and the average best fit line are relatively small, indicating that the sensors are behaving as expected.

The plot 450 illustrates a scenario where an anomaly has occurred, causing a breakdown in the inverse correlation between the sensor signals. The line 412 and the line 414 now deviate significantly from their expected behavior. This is reflected in the large vertical distances (d₁ 422, d₂ 424) between each sensor value and the average historical value for each correlated pair (e.g., the line 420).

The vertical distances d₁ 422 and d₂ 424 represent the deviations of each sensor value from the average historical value for each correlated pair at a specific time step. These deviations are used to calculate a deviation metric bₜ, which may be a component of the hybrid statistical approach described above.

The graph 400 considers both the magnitude and rate of change when analyzing the relationship between sensor signals. In a normal scenario, the deviations (d₁ 422, d₂ 424) are small, indicating that the sensors are behaving in accordance with their expected inverse correlation. However, in the anomalous scenario, the large deviations signal a breakdown in this correlation, which could be indicative of a developing equipment issue. By incorporating both the absolute difference metric (e.g., a deviation metric aₜ) and the average historical value deviation metric (e.g., the deviation metric bₜ described above), the hybrid statistical approach is able to detect both sudden shifts and gradual trends in sensor behavior, providing a more comprehensive and sensitive method for identifying potential equipment failures.

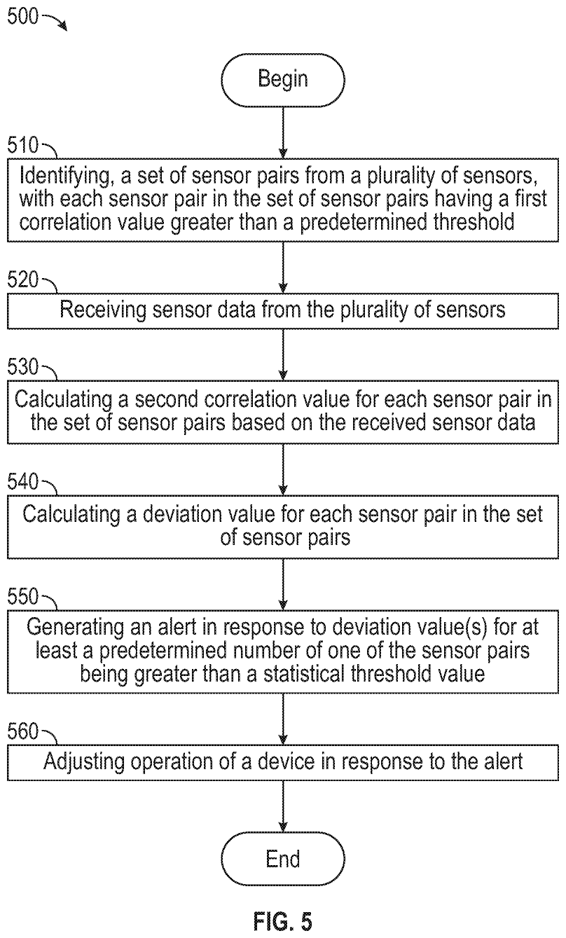

FIG. 5 illustrates a method 500 for equipment health monitoring according to an embodiment of the disclosure. The method 500 identifies correlated sensor pairs and establishes baseline models for their behavior, allowing for the detection of anomalies that may indicate potential equipment failures. The method 500 encompasses several steps, including data acquisition, correlation analysis, statistical modeling, monitoring, alert generation, and user feedback integration. By analyzing sensor data and establishing thresholds, the method 500 may provide a more comprehensive and proactive approach to equipment health monitoring.

At step 510, the method 500 includes identifying a set of sensor pairs from a plurality of sensors. This identification process is based on analyzing historical sensor data to determine degrees of correlation between different sensor pairs.

Each sensor pair in the set of sensor pairs has a first correlation value greater than a predetermined threshold. The first correlation value refers to a statistical measure that quantifies the strength and direction of the linear relationship between the historical sensor data of two sensors within a pair. A high correlation value (e.g., close to +/−1) indicates that the sensors tend to change together predictably, suggesting a strong relationship between the parameters they measure.

The identification of correlated sensor pairs in step 510 may include sub-steps, including data retrieval, pairwise correlation calculation, and threshold filtering. Historical sensor data for all sensors associated with the equipment may be retrieved from an asset model (e.g., the asset model 240). The correlation coefficient (e.g., a Pearson correlation coefficient) may be calculated for each possible pair of sensors using the historical data. Sensor pairs with a correlation coefficient exceeding the predetermined threshold may be selected and included in the set of sensor pairs.

At step 520, the method 500 includes receiving sensor data from the plurality of sensors (e.g., sensors 210) associated with the equipment being monitored. This data stream may serve as the input for the subsequent analysis and anomaly detection processes within an equipment health monitoring system (e.g., the equipment health monitoring system 100). This received data stream may be relatively recent sensor data, such as sensor data from the last 10 seconds, 1 minute, 10 minutes, or the like.

The sensor data in this context refers to the stream of digital and/or analog data that indicates measurements captured by sensors (e.g., sensors 210). The stream of measurements may be continuous and/or discrete. These measurements may represent various physical parameters of the equipment, such as temperature, pressure, vibration, flow rate, current, voltage, or acoustic emissions. Data may be acquired at regular intervals, providing a dynamic snapshot of equipment operating conditions.

Receiving sensor data in step 520 may include data acquisition, transmission, and processing sub-steps. For example, a data acquisition system (e.g., the data acquisition system 230) may collect the raw sensor data from the sensors (e.g., sensors 210) at a specified sampling rate. The acquired data may then be transmitted from the data acquisition system to the equipment health monitoring system via a wired or wireless communication channel. Then, the received sensor data may undergo preprocessing steps, such as filtering, normalization, or aggregation, before being used for analysis.

Receiving recent sensor data may be useful for the continuous monitoring of equipment health. By analyzing this data stream, the equipment health monitoring embodiments described herein may detect subtle changes in sensor readings that may be early indicators of developing anomalies or impending failures.

At step 530, the method 500 includes calculating a second correlation value for each sensor pair in the set of sensor pairs identified in step 510 based on the received sensor data from step 520. The second correlation value represents the current degree of correlation between the two sensors in each pair, reflecting their time-specific behavior and relationship. That is, the second correlation value is based on recent sensor data, whereas the first correlation value used in step 510 is based on historical sensor data.

The second correlation value is a dynamic measure that may change over time as new sensor data is received. The second correlation value thus reflects how closely the time-specific sensor readings of a pair are following their established correlation pattern, as determined from historical data. Calculating the second correlation value may be based on the same statistical measure (e.g., Pearson correlation coefficient) used in step 510 to initially identify the correlated pairs.

The calculation of the second correlation value in step 530 may be broken down into data windowing, pairwise correlation calculation, and correlation value update sub-steps. A sliding window of sensor data is defined, typically encompassing a recent period (e.g., the last hour, day, or week). The window size may be adjusted based on the system's desired responsiveness and sensitivity. For each identified sensor pair, the correlation coefficient may then be calculated using the sensor data within the sliding window. This may provide a snapshot of the current correlation strength between the two sensors. The calculated correlation coefficient becomes the new second correlation value for that sensor pair. This value may then be used to compare against the established threshold in the next step.

The embodiments described herein are not limited to a particular amount of recency, but should be interpreted as encompassing correlation values based on real time data, data acquired within the last second, data acquired within the last 1-10 seconds, data acquired within the last 11-60 seconds, and the like. In some examples, the second correlation value is thus received in near-real-time. This may aid the equipment health monitoring system in responding more efficiently to changes in equipment behavior.

At step 540, the method 500 may include calculating a deviation value for each sensor pair in the set of sensor pairs. The deviation value is a measure of the discrepancy between the expected correlation (i.e., first correlation value) and observed correlation (i.e., second correlation value) of a sensor pair. A large deviation value may indicate that the sensors are behaving significantly differently compared to their historical pattern, suggesting a potential anomaly or degradation (e.g., failure) in the equipment health.

The deviation value is calculated as a difference between the first correlation value (obtained from historical data) and the second correlation value (calculated from received data). This may be expressed mathematically as:

Deviation Value=|(First Correlation Value−Second Correlation Value)| (1)

The absolute value may be used so that the deviation value is always positive, regardless of whether the correlation has increased or decreased. By quantifying the change in correlation between historical and as-received behavior, the equipment health monitoring system can identify sensor pairs that are exhibiting unusual patterns, which may be indicative of developing equipment issues.

At step 550, the method 500 includes generating an alert in response to deviation value(s) for at least a predetermined number of the sensor pairs being greater than a statistical threshold value. Step 550 may be the culmination of the anomaly detection process, translating the quantitative analysis of sensor data into actionable information for equipment operators and maintenance personnel.

The alert generation process in step 550 may involve several aspects. The system evaluates the deviation value calculated for each correlated sensor pair in step 540. This deviation value represents the change in correlation between the historical and as-received behavior of the sensors. If the deviation value for a sensor pair surpasses a predetermined statistical threshold, it signals a potential anomaly.

The alert may not be triggered based on a single sensor pair exceeding its threshold. Instead, the equipment health monitoring system may require that a predetermined number of sensor pairs exhibit anomalous behavior before an alert is generated. This may help to reduce false positives and increase the likelihood that the alert is indicative of a pertinent issue with the equipment.

Further, while generating the alert, the system may suppress the alert if an alert for a device (e.g., a piece of equipment) has been generated within a predetermined time period. To do this, the system may maintain a history of alerts generated for each device. This history may include information such as the time of the alert, the sensor pair(s) that triggered it, and the nature of the anomaly. A configurable time period (e.g., hours, days, weeks) may be defined as the suppression window. This window may determine how long after a previous alert a device is considered to be in an alert suppression state. When a new alert is triggered for a device, the system may check if a previous alert for the same device has been generated within the suppression window. If so, the new alert may be suppressed, meaning it is not communicated to a user.

Additionally, when generating an alert, the system may determine a percentage of sensor pairs in the set of sensor pairs that exceed their respective statistical threshold values and generate the alert if the percentage exceeds a predetermined threshold. To calculate the percentage of sensor pairs, the system may first determine the number of sensor pairs in the set whose deviation values exceed their corresponding thresholds. This number may then be divided by the total number of sensor pairs in the set and multiplied by 100 to obtain the percentage of anomalous pairs. A predefined percentage threshold may be established, representing the minimum percentage of anomalous sensor pairs required to trigger an alert. This threshold may be adjusted based on the desired sensitivity and specificity of the system, as well as the specific equipment being monitored. If the calculated percentage of anomalous sensor pairs exceeds the predetermined threshold, the system may generate an alert. This alert may indicate that a portion of the sensors are deviating from their expected behavior, suggesting a potential issue with the equipment that warrants further investigation.

The generated alert may include information about the affected equipment, the specific sensor pairs that triggered the alert, the magnitude of the deviation, and potentially a recommended course of action. This information may be useful for operators and maintenance personnel to quickly assess the situation and prioritize their response.

The statistical threshold for each sensor pair may be determined during the training phase of a statistical model (e.g., the statistical model 250). The statistical threshold represents a boundary beyond which deviations are considered statistically significant and likely indicative of an equipment anomaly. The specific calculation of the threshold may vary depending on the statistical model used and the desired sensitivity of the system.

The statistical threshold value may be based on a combined deviation value. Calculating the combined deviation value may done by combining a second deviation value and a third deviation value for each correlated sensor pair in the set of correlated sensor pairs.

Calculating the second deviation value involves analyzing the historical sensor data for each correlated sensor pair. The second deviation value represents the difference between the historical sensor data of the sensors in the correlated sensor pair. The historical sensor data may be divided into discrete time steps (e.g., 10-minute intervals). At each time step, the system may capture a snapshot of the sensor values for the correlated pair. The absolute difference may be calculated between the two sensor values at each time step. This difference represents the magnitude of the discrepancy between the sensor readings at that moment in time.

The second deviation value may be further refined by introducing a normalization calculation involving the median of absolute differences. Such a refinement may improve the sensitivity and robustness of anomaly detection by accounting for the baseline variability in the relationship between the correlated sensor pair. After calculating the absolute difference between the historical sensor data of the two sensors in the correlated pair at each time step, yielding a series of absolute differences across multiple time steps, the median of these absolute differences may then be determined. The median is a statistical measure that represents the middle value of a dataset when sorted in ascending order. In this context, it may serve as an estimate of the expected magnitude of difference between the two sensor readings. The median value may then be subtracted from each individual absolute difference calculated. Doing this may effectively normalize the absolute differences, centering them around zero. By removing the baseline variability, the system may more easily identify deviations that are truly anomalous and indicative of potential equipment issues.

By taking the absolute value, the system focuses on the magnitude of the difference rather than its direction (positive or negative). The use of absolute differences at each time step may provide a more nuanced understanding of the historical relationship between the sensors in a correlated pair. It may allow the system to capture not only the overall correlation between the sensors but also the variability in their relationship over time. This may be useful for detecting anomalies that may not be apparent when looking at aggregated or averaged data.

Further, the use of median normalization may offer several anomaly detection enhancements. The median is less sensitive to extreme values or outliers compared to the mean, making the calculation of the second deviation value more robust to noisy or fluctuating data. By normalizing the absolute differences, the system can more easily set a threshold for identifying anomalies. This threshold may be based on the standard deviation or other statistical measures of the normalized differences, allowing for more adaptive and dynamic alert generation. The normalized deviation values may highlight subtle shifts or trends in the relationship between the sensor pair, which may improve the system's ability to detect early warning signs of equipment degradation.

Calculating the third deviation value involves analyzing the deviations of historical sensor data of the sensors in the correlated sensor pair from a respective average of historical sensor data for that sensor pair. For the sensors in the correlated pair, the system may calculate a combined average of historical sensor data from both sensors over the predetermined time period (e.g., one year). This average value represents the sensor pair's expected behavior. The system may then determine the deviation of each historical data point from the corresponding sensor pair's average. This may be done by subtracting the average value from each individual data point. Finally, the system may calculate the absolute difference between the deviations of the two sensors at each time step. This absolute difference may represent the third deviation value for that time step. This metric captures the degree to which the sensors deviate from their combined average behavior.

The second and third deviation values may be combined to form a single metric, the combined deviation value. This may be achieved through various methods, such as simple addition, multiplication, or a weighted average. The combined deviation value may provide a more comprehensive representation of the historical variability in the relationship between the sensor pair, taking into account both the magnitude of fluctuations and the deviations from individual sensor averages.

The combined deviation values for a portion of the historical sensor data determined to be least anomalous may be used to calculate a mean and standard deviation. The statistical threshold value may then be determined based on these mean and standard deviation, generally by adding a multiple of the standard deviation to the mean. This threshold represents the boundary beyond which real-time deviations are considered statistically significant and likely indicative of an equipment anomaly.

At step 560, the method 500 includes adjusting operation of a device in response to the alert. That is, in step 560, based on the generation of an alert in step 550, the system may initiate a process to adjust the equipment operation (e.g., changing control parameters, performing equipment maintenance, resetting the equipment). The adjusted equipment is associated with the set of sensor pairs that resulted in the alert being generated. The device may be a wide range of equipment (e.g., pumps, compressors, heat exchangers), devices, machines, or systems. Adjusting the operation of the equipment is designed to mitigate the impact of detected anomalies and potentially prevent further equipment degradation or failure. In some examples, equipment operation is not adjusted in response to all alerts. For example, the decision to adjust equipment operation may depend on various factors, such as the severity of the anomaly, the criticality of the equipment, the availability of human intervention, and the potential impact on the broader system in which the to-be-adjusted equipment resides.

Adjusting operations of the device may encompass a range of actions to restore the equipment to a known or desired state. The specific adjusting operation may depend on the nature of the equipment, the detected anomaly, and the capabilities of the system. Possible adjusting operations could include restarting the equipment, adjusting operating parameters, isolating faulty components, or triggering maintenance actions. For example, powering down and then restarting the equipment may clear transient errors or reset parameters to default values. Alternatively, the system could automatically adjust control parameters, such as flow rate, pressure, or temperature, to bring the equipment back within safe operating limits. If the anomaly is localized to a specific component, the system could isolate that component to prevent further damage or disruption to the overall system. Further, the system could notify maintenance personnel or automatically initiate a maintenance workflow to address the underlying issue causing the anomaly.

The ability to adjust operations of the device in response to alert may add an additional layer of automation and responsiveness to the equipment health monitoring system. By taking action to mitigate detected anomalies, the system can potentially prevent further equipment degradation, reduce downtime, and improve overall safety.

Operation adjustment actions and the logic for triggering them may be customized based on the characteristics of the equipment and the desired operational outcomes. The equipment health monitoring system may be integrated with existing control systems, allowing for automation of adjusting operation processes.

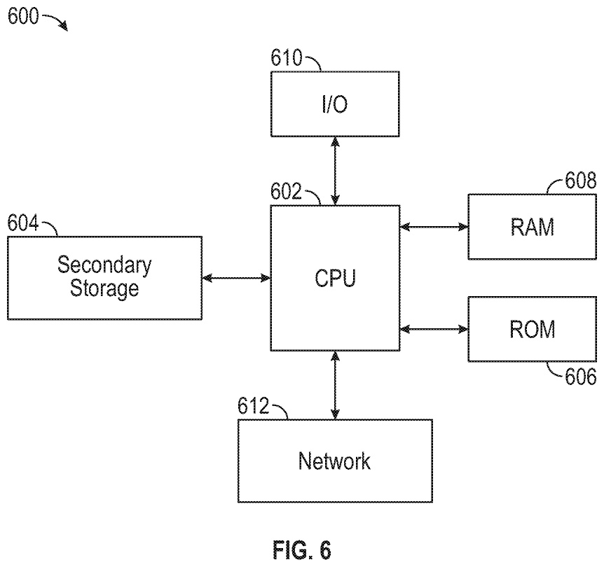

Referring now to FIG. 6, a computer system 600 suitable for implementing one or more embodiments disclosed herein is shown. Any of the methods disclosed herein can be carried out (e.g., entirely or partially) on a computer or other device comprising a processor (e.g., a desktop computer, a laptop computer, a tablet, a server, a smartphone, or some combination thereof). The computer system 600 includes a processor 602 (which may be referred to as a central processor unit or CPU) that is in communication with memory devices, including secondary storage 604, read-only memory (ROM) 606, random access memory (RAM) 608, input/output (I/O) devices 610, and network connectivity devices 612. The processor 602 may be implemented as one or more CPU chips.

It is understood that by programming and/or loading executable instructions onto the computer system 600, at least one of the CPUs 602, the RAM 608, and the ROM 606 are changed, transforming the computer system 600 in part into a particular machine or apparatus having the novel functionality taught by the present disclosure. Thus, the RAM 608 and/or the ROM 606 may comprise a non-transitory machine-readable (or computer-readable) medium that may include instructions (which may be referred to herein as machine-readable instructions) that are executable by CPU 602 to provide functionality to computer system 600. Thus, in some embodiments, a machine-readable instructions stored on a memory may be executed on a processor, so as to configured the processor to carry out some or all of the features of the methods described herein (e.g., method 600).

It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware (for example in an application-specific integrated circuit (ASIC), or field-programmable gate arrays (FPGA)) because for large production runs the hardware implementation may be less expensive than the software implementation. Often, a design may be developed and tested in software form and later transformed, by well-known design rules, into an equivalent hardware implementation in an application-specific integrated circuit that hardwires the instructions of the software. In the same manner as a machine controlled by a new ASIC is a particular machine or apparatus, likewise, a computer that has been programmed and/or loaded with executable instructions may be viewed as a particular machine or apparatus.

Additionally, after the system 600 is turned on or booted, the CPU 602 may execute a computer program or application. For example, the CPU 602 may execute software or firmware stored in the ROM 606 or stored in the RAM 608. In some cases, on boot and/or when the application is initiated, the CPU 602 may copy the application or portions of the application from the secondary storage 604 to the RAM 608 or to memory space within the CPU 602 itself, and the CPU 602 may then execute instructions of which the application is comprised. In some cases, the CPU 602 may copy the application or portions of the application from memory accessed via the network connectivity devices 612 or via the I/O devices 610 to the RAM 608 or to memory space within the CPU 602, and the CPU 602 may then execute instructions of which the application is comprised. During execution, an application may load instructions into the CPU 602, for example, load some of the instructions of the application into a cache of the CPU 602. In some contexts, an application that is executed may be said to configure the CPU 602 to do something, e.g., to configure the CPU 602 to perform the function or functions promoted by the subject application. When the CPU 602 is configured in this way by the application, the CPU 602 becomes a specific-purpose computer or a specific-purpose machine.

The secondary storage 604 is typically comprised of one or more disk drives or tape drives and is used for non-volatile storage of data and as an over-flow data storage device if RAM 608 is not large enough to hold all working data. Secondary storage 604 may be used to store programs which are loaded into RAM 608 when such programs are selected for execution. The ROM 606 is used to store instructions and perhaps data which are read during program execution. ROM 606 is a non-volatile memory device which typically has a small memory capacity relative to the larger memory capacity of secondary storage 604. The RAM 608 is used to store volatile data and perhaps to store instructions. Access to both ROM 606 and RAM 608 is typically faster than secondary storage 604. The secondary storage 604, the RAM 608, and/or the ROM 606 may be referred to in some contexts as computer-readable storage media and/or non-transitory computer-readable media.

I/O devices 610 may include printers, video monitors, electronic displays (e.g., liquid crystal displays (LCDs), plasma displays, organic light emitting diode displays (OLED), touch sensitive displays), keyboards, keypads, switches, dials, mice, track balls, voice recognizers, card readers, paper tape readers, or other well-known input devices.

The network connectivity devices 612 may take the form of modems, modem banks, Ethernet cards, Omni-Path Architecture (OPA), InfiniBand (IB), universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 612 may enable the processor 602 to communicate with the Internet or one or more intranets. With such a network connection, it is contemplated that the processor 602 might receive information from the network, or might output information to the network (e.g., to an event database) in the course of performing the methods described herein. Such information, which is often represented as a sequence of instructions to be executed using processor 602, may be received from and outputted to the network, for example, in the form of a computer data signal embodied in a carrier wave.

Such information, which may include data or instructions to be executed using processor 602, for example, may be received from and outputted to the network, for example, in the form of a computer data baseband signal or signal embodied in a carrier wave. The baseband signal or signal embedded in the carrier wave, or other types of signals currently used or hereafter developed, may be generated according to several known methods. The baseband signal and/or signal embedded in the carrier wave may be referred to in some contexts as a transitory signal.

The processor 602 executes instructions, codes, computer programs, scripts which it accesses from hard disk, floppy disk, optical disk, solid state drives (SSD) (these various disk-based systems may all be considered secondary storage 604), flash drive, ROM 606, RAM 608, or the network connectivity devices 612. While only one processor 602 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 604, for example, hard drives, floppy disks, optical disks, and/or other device, the ROM 606, and/or the RAM 608 may be referred to in some contexts as non-transitory instructions and/or non-transitory information.

In an embodiment, the computer system 600 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 600 to provide the functionality of a number of servers that is not directly bound to the number of computers in the computer system 600. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer-readable storage mediums having computer-usable program code embodied therein to implement the functionality disclosed above. The computer program product may comprise data structures, executable instructions, and other computer-usable program code. The computer program product may be embodied in removable computer storage media and/or non-removable computer storage media. The removable computer-readable storage medium may comprise, without limitation, a paper tape, a magnetic tape, a magnetic disk, an optical disk, a solid-state memory chip, for example, analog magnetic tape, compact disk read-only memory (CD-ROM) disks, floppy disks, jump drives, digital cards, multimedia cards, and others. The computer program product may be suitable for loading, by the computer system 600, at least portions of the contents of the computer program product to the secondary storage 604, to the ROM 606, to the RAM 608, and/or to other non-volatile memory and volatile memory of the computer system 600. The processor 602 may process the executable instructions and/or data structures in part by directly accessing the computer program product, for example, by reading from a CD-ROM disk inserted into a disk drive peripheral of the computer system 600. Alternatively, the processor 602 may process the executable instructions and/or data structures by remotely accessing the computer program product, for example, by downloading the executable instructions and/or data structures from a remote server through the network connectivity devices 612. The computer program product may comprise instructions that promote the loading and/or copying of data, data structures, files, and/or executable instructions to the secondary storage 604, to the ROM 606, to the RAM 608, and/or to other non-volatile memory and volatile memory of the computer system 600.

In some contexts, the secondary storage 604, the ROM 606, and the RAM 608 may be referred to as a non-transitory computer-readable medium or a computer-readable storage media. A dynamic RAM embodiment of the RAM 608, likewise, may be referred to as a non-transitory computer-readable medium in that while the dynamic RAM receives electrical power and is operated in accordance with its design, for example during a period of time during which the computer system 600 is turned on and operational, the dynamic RAM stores information that is written to it. Similarly, the processor 602 may comprise an internal RAM, an internal ROM, a cache memory, and/or other internal non-transitory storage blocks, sections, or components that may be referred to in some contexts as non-transitory computer-readable media or computer-readable storage media. At least some, if not all, of the steps or “blocks” of method 500 shown in FIG. 5 may be executed by the computer system 600 shown in FIG. 6, although it is to be understood that at least some of the steps of method 500 may be executed by systems other than computer system 600.

While several embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

As such, the preceding discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the preceding description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

In the preceding discussion and the claims, the terms “including” and “comprising” are used in an open-ended fashion and thus should be interpreted to mean “including, but not limited to . . . .” Also, the term “couple” or “couples” is intended to mean either an indirect or direct connection. Thus, if a first device couples to a second device, that connection may be through a direct engagement between the two devices or through an indirect connection established via other devices, components, nodes, and connections. In addition, as used herein, the terms “axial” and “axially” generally mean along or parallel to a particular axis (e.g., a central axis of a body or a port), while the terms “radial” and “radially” generally mean perpendicular to a particular axis. For example, an axial distance refers to a distance measured along or parallel to the axis, and a radial distance means a distance measured perpendicular to the axis. Any reference to up or down in the description and the claims is made for purposes of clarity, with “up,” “upper,” “upwardly,” “uphole,” or “upstream” meaning toward the surface of the borehole and with “down,” “lower,” “downwardly,” “downhole,” or “downstream” meaning toward the terminal end of the borehole, regardless of the borehole orientation.

As used herein, the terms “approximately,” “about,” “substantially,” and the like mean within 10% (i.e., plus or minus 10%) of the recited value unless otherwise stated. Thus, for example, a recited angle of “about 80 degrees” refers to an angle ranging from 72 degrees to 88 degrees. Where single components, apparatuses, or systems are described as performing functions, multiple such components, apparatuses, or systems may implement the functions.

Thus, while several embodiments have been provided, the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented. Likewise, where single components, apparatuses, or systems are described as performing functions, multiple such components, apparatuses, or systems may implement the functions.

What is claimed is:

1. A method, comprising:
identifying, from a plurality of sensors, a set of sensor pairs, wherein each sensor pair in the set of senor pairs has a first correlation value greater than a predetermined threshold;
receiving sensor data from the plurality of sensors;
calculating a second correlation value for each sensor pair in the set of sensor pairs based on the received sensor data;
calculating a deviation value for each sensor pair in the set of sensor pairs, wherein the deviation value comprises a difference between the first correlation value and the second correlation value for that sensor pair; and
generating an alert in response to deviation value(s) for at least a predetermined number of the sensor pairs being greater than a statistical threshold value.

2. The method of claim 1, wherein the plurality of sensors are associated with a device, and wherein the method further comprises adjusting operation of the device in response to the alert.

3. The method of claim 1, wherein for each sensor pair in the set of sensor pairs, the method further comprises:
calculating a second deviation value based on a difference between historical sensor data of the sensors in the sensor pair;
calculating a third deviation value based on deviations of historical sensor data of the sensors in the sensor pair from a respective average of historical sensor data; and
calculating a combined deviation value by combining the second deviation value and the third deviation value, wherein the statistical threshold value is based on the combined deviation value.

4. The method of claim 3, wherein calculating the second deviation value for a sensor pair further comprises determining an absolute difference between historical sensor data of the sensors in the sensor pair at each time step.

5. The method of claim 4, wherein calculating the second deviation value further comprises determining a median value of absolute differences across multiple time steps and subtracting the median value from each absolute difference.

6. The method of claim 3, wherein calculating the combined deviation value for a sensor pair comprises multiplying the second deviation value and the third deviation value.

7. The method of claim 3, wherein calculating the third deviation value for a sensor pair comprises determining a deviation of historical sensor data for each sensor from an average of historical sensor data for that sensor, and then determining an absolute difference between historical sensor data for each sensor and the average of historical sensor data for that sensor.

8. The method of claim 1, wherein the predetermined threshold for identifying sensor pairs is based on a Pearson correlation coefficient.

9. The method of claim 1, wherein generating the alert comprises suppressing the alert if an alert for an apparatus has been previously generated within a predetermined time period.

10. The method of claim 1, wherein generating the alert comprises determining a percentage of sensor pairs in the set of sensor pairs that exceed their respective statistical threshold values, and generating the alert if the percentage exceeds a predetermined percentage threshold.

11. The method of claim 1, wherein calculating the statistical threshold value for a sensor pair comprises calculating a mean and standard deviation of combined deviation values for a portion of historical sensor data determined to be least anomalous, and determining the statistical threshold value based on the mean and standard deviation.

12. A system, comprising:
a plurality of sensors;
an electronic device coupled to the plurality of sensors, the electronic device comprising:
one or more processors; and
a memory coupled to the one or more processors and storing instructions that, when executed by the one or more processors, cause the electronic device to be configured to:
identify, from the plurality of sensors, a set of sensor pairs, wherein each sensor pair in the set of senor pairs has a first correlation value greater than a predetermined threshold;
receive sensor data from the plurality of sensors;
calculate a second correlation value for each sensor pair in the set of sensor pairs based on the received sensor data;
calculate a deviation value for each sensor pair in the set of sensor pairs, wherein the deviation value comprises a difference between the first correlation value and the second correlation value for that sensor pair; and
generate an alert in response to deviation value(s) for at least a predetermined number of the sensor pairs being greater than a statistical threshold value.

13. The system of claim 12, wherein the plurality of sensors are associated with a device, and wherein the electronic device is further configured to adjust operation of the device in response to the alert.

14. The system of claim 12, wherein for each correlated sensor pair in the set of correlated sensor pairs, the electronic device is further configured to:
calculate a second deviation value based on a difference between historical sensor data of the sensors in the correlated sensor pair;
calculate a third deviation value based on deviations of historical sensor data of the sensors in the correlated sensor pair from a respective average of historical sensor data; and
calculate a combined deviation value by combining the second deviation value and the third deviation value, wherein the statistical threshold value is based on the combined deviation value.

15. The system of claim 14, wherein calculating the second deviation value for a correlated sensor pair further comprises determining an absolute difference between historical sensor data of the sensors in the correlated sensor pair at each time step.

16. The system of claim 15, wherein calculating the second deviation value further comprises determining a median value of absolute differences across multiple time steps and subtracting the median value from each absolute difference.

17. The system of claim 14, wherein calculating the combined deviation value for a correlated sensor pair comprises multiplying the second deviation value and the third deviation value.

18. The system of claim 12, wherein generating the alert comprises suppressing the alert if an alert for an apparatus has been previously generated within a predetermined time period.

19. The system of claim 12, wherein generating the alert comprises determining a percentage of sensor pairs in the set of sensor pairs that exceed their respective statistical threshold values, and generating the alert if the percentage exceeds a predetermined percentage threshold.

20. A non-transitory computer-readable medium storing instructions that, when executed by one or more processors of an electronic device, cause the electronic device to be configured to:
identify, from a plurality of sensors, a set of sensor pairs, wherein each sensor pair in the set of senor pairs has a first correlation value greater than a predetermined threshold;
receive sensor data from the plurality of sensors;
calculate a second correlation value for each sensor pair in the set of sensor pairs based on the received sensor data;
calculate a deviation value for each sensor pair in the set of sensor pairs, wherein the deviation value comprises a difference between the first correlation value and the second correlation value for that sensor pair; and
generate an alert in response to deviation value(s) for at least a predetermined number of the sensor pairs being greater than a statistical threshold value.
